(19) United States
(12) Patent Application Publication
(10) Pub. No.: US 2011/0271595 A1
(43) Pub. Date: Nov. 10, 2011

(54) DRIVE ARRANGEMENT FOR MOTOR-OPERATED ADJUSTMENT OF A CLOSURE ELEMENT IN A MOTOR VEHICLE

(76) Inventors: Jürgen Eggeling, Mulheim an der Ruhr (DE); Dirk Hellmich, Duisburg (DE); Klaus Dünne, Ratingen (DE)

(21) Appl. No.: 13/128,826

(22) PCT Filed: Oct. 8, 2009
(86) PCT No.: PCT/EP2009/007222

§ 371 Date: Jul. 25, 2011

(30) Foreign Application Priority Data
Nov. 12, 2008 (DE) 10 2008 057 014.1

(51) Int. Cl. E05F 15/12; E05F 3/00

(52) U.S. Cl. 49/358

(57) ABSTRACT

Disclosed herein is a drive arrangement for motor-operated adjustment of a closure element in a motor vehicle having at least one drive with a drive motor, and a drive controller. The closure element can be driven in the motor-operated adjustment mode by the drive motor in the closing direction and in the opening direction between a closed and an open position. The drive is non-self-locking and has a sensor, in particular a Hall sensor, for sensing the drive movement. The drive controller monitors the sensor signals for a fault state, and when a fault state is sensed initiates an emergency braking and/or stop mode. The drive arrangement comprises two drives each with a sensor for determining the respective drive movement. To detect fault-induced slamming shut of the closure element, the drive controller correlates the sensor signals of the two sensors, in particular compares said sensor signals.

### CROSS REFERENCE TO RELATED APPLICATIONS

This application is a national stage application under 35 U.S.C. 371 of International Patent Application Serial No. PCT/EP2009/007222, entitled “ DRIVE ARRANGEMENT FOR MOTOR-OPERATED ADJUSTMENT OF A CLOSURE ELEMENT IN A MOTOR VEHICLE,” filed Oct. 8, 2009, which claims priority from German Patent Application No. 10 2008 057 014.1, filed Nov. 12, 2008, the disclosures of which are incorporated herein by reference.

### FIELD OF THE INVENTION

The invention relates to a drive arrangement for motor-operated adjustment of a closure element in a motor vehicle, and to a closure element arrangement in a motor vehicle.

### BACKGROUND OF THE INVENTION

The term “closure element” is to be understood here in an inclusive fashion. It includes tailgates, trunk lids, engine hoods, side doors, sliding doors, lifting roofs, sliding windows, etc.

However, the drive arrangement in question is primarily applied in tailgates and side doors in motor vehicles. It serves for motor-operated adjustment of the respective closure element in the closing direction and in the opening direction.

The known drive arrangement (DE 20 2005 007 155 U1) on which the invention is based is assigned to a tailgate of a motor vehicle. The drive arrangement is equipped with two spindle drives which each have, in a compact structural unit, a drive motor, an intermediate transmission with a clutch and a spindle/spindle nut mechanism. A spring arrangement, which counteracts the weight of the assigned tailgate, is provided in the respective structural unit.

The known drive arrangement also has a drive controller which serves to actuate the two drives, in particular the two drive motors. The drives are generally each configured with a sensor for sensing the drive movement. Tailgates of considerable size and/or considerable weight can be adjusted by motor with the known drive arrangement. This opens new degrees of freedom in the configuration of such tailgates. However, the increase in the weight basically also involves an increased risk when the drive arrangement fails.

In the most unfavorable case, the drive connection between the drive arrangement and the tailgate ruptures, which would cause the tailgate to suddenly slam shut. This involves overall a considerable restriction of the operational safety of the tailgate arrangement.

### SUMMARY OF THE INVENTION

The invention is based on the problem of configuring and developing the known drive arrangement in such a way that the operational safety is increased.

The above problem is solved in a drive arrangement for motor-operated adjustment of a closure element in a motor vehicle, wherein at least one drive with a drive motor, and a drive controller are provided, wherein the closure element can be driven in the motor-operated adjustment mode by means of the drive motor in the closing direction and in the opening direction between a closed position and an open position, wherein the drive is of non-self-locking design, wherein the drive has a sensor, in particular a Hall sensor, for sensing the drive movement, wherein the drive controller monitors the sensor signals for a fault state, and when a fault state is sensed said drive controller initiates an emergency braking mode and/or an emergency stop mode, in that the drive arrangement comprises two drives each with a sensor for determining the respective drive movement, and in that, in order to detect fault-induced slamming shut of the closure element, the drive controller correlates the sensor signals of the two sensors with one another, in particular compares said sensor signals with one another.

It is essential that the drive controller monitor the sensor signals of the sensor or of the sensors of the drive or drives for a fault state and initiate an emergency braking mode and/or an emergency stop mode when a fault state is detected. It has been realized here that the sensor signals which serve to control the movement per se can be used to detect deviations from the normal operating state.

In one embodiment, the fault state which is to be monitored relates to fault-induced slamming shut of the closure element. This fault state is in the spotlight here.

In particular, the teaching is based on the fault state in which one of the two drives of the drive arrangement becomes disengaged from the closure element, which in turn leads to fault-induced slamming shut of the closure element. This fault state is detected according to the proposal in that the sensor signals of the two sensors are correlated with one another. In the simplest case, a comparison of the sensor signals of the two sensors takes place here.

In another embodiment, it has been detected that the drive motor or drive motors of the drive or drives can readily be actuated in such a way that the braking effect which is necessary for the emergency braking mode or the emergency stop mode is brought about.

There are, at any rate, two possible ways of generating the abovementioned braking effect of the drive motor.

One way is to connect the drive motor to a short circuit, preferably in a pulsed fashion. As a result, a braking effect is generated which is due to the Lorentz force.

Another way of generating the braking effect of the drive motor is to apply a preferably pulsed countervoltage and/or a preferably pulsed countercurrent to the drive motor. As a result, an even stronger braking effect than with the short-circuit braking can be achieved.

According to a further teaching, which is also attributed independent significance, a closure element arrangement which has a closure element on one hand and a drive arrangement on the other is claimed as such. Reference can be made to the full scope of the statements relating to possible variants of the closure element and of the drive arrangement.

### BRIEF DESCRIPTION OF THE FIGURES

Further details, features, objectives and advantages of the present invention will be explained in more detail below with reference to the drawing of a preferred exemplary embodiment. In the drawing:

FIG. 1 shows the rear of a motor vehicle in a side view with a tailgate and a drive arrangement, according to the proposal, for the motor-operated adjustment of the tailgate,

FIG. 2 shows a drive of the drive arrangement according to FIG. 1 in a sectional illustration,

FIG. 3 is a schematic view of the control system of the drive controller of the drive arrangement according to FIG. 1, and

FIG. 4 shows the power output stage of the drive controller of the drive arrangement according to FIG. 1.

### DETAILED DESCRIPTION

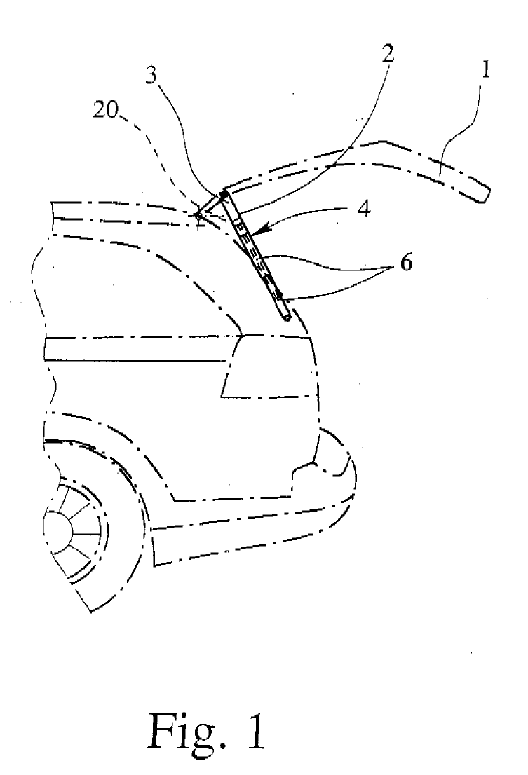

The drive arrangement illustrated in FIG. 1 serves for motor-operated adjustment of a tailgate 1 in a motor vehicle. However, all other closure elements which are referred to in the introductory part of the description can advantageously be used. All the following statements relating to a tailgate apply correspondingly to the same extent to all other closure elements which are referred to.

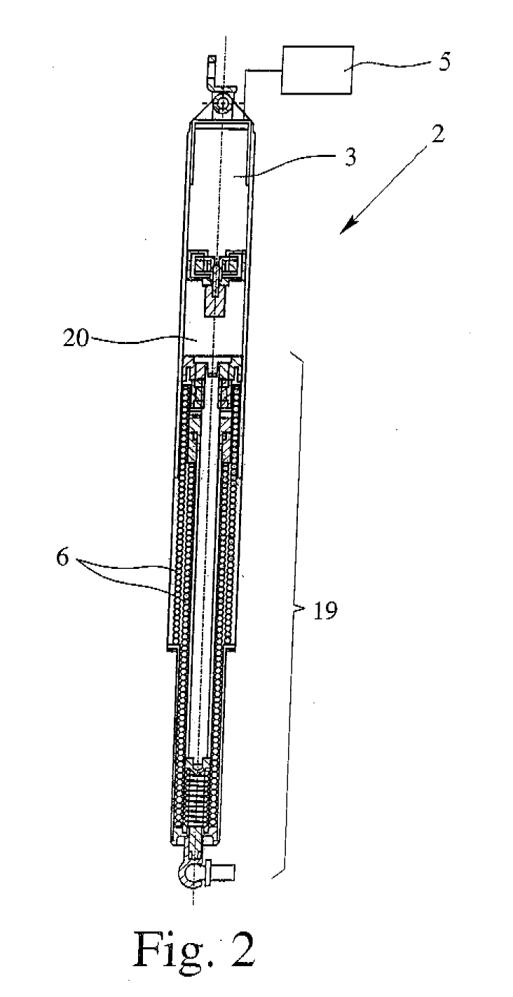

Basically, a single drive 2 can be assigned to the drive arrangement. However, the drive arrangement illustrated in FIG. 1 is assigned two identical drives 2, which each have a drive motor 3. The drives 2 are arranged in the two lateral areas of a tailgate opening 4. Just one of the two drives 2 is illustrated in FIG. 1. FIG. 2 shows this drive 2 in a sectional view.

The following statements apply almost consistently only to the drive 2 which can be seen in FIG. 1. However, they apply equally to further drives which may be present where applicable.

It can be stated in respect of the above that in specific application cases a single drive motor 3 can be assigned to a plurality of drives 2, preferably two thereof. The plurality of drives 2 then, as it were, share the one drive motor 3.

In addition, a drive controller 5 is provided which is assigned to the drive 2 or the drives 2. Said drive controller 5 will be explained in more detail below.

All the exemplary embodiments have in common the fact that the tailgate 1 can be driven in the motor-operated adjustment mode by means of the drive motor 3 in the closing direction and in the opening direction between a closed position and an open position.

In the mounted state, the arrangement is such that the weight of the closure element 1 acts in the closing direction. In this case, the drives 2 are not configured here in a self-locking way, with the result that the weight of the closure element 1 can basically trigger a closing movement of the closure element 1. In order to prevent this, a prestressing of the drives 2 and/or of the closure element 1 is generally provided, as will be explained.

The drive 2 is equipped with a sensor (not illustrated) for sensing the drive movement. The sensor is preferably a Hall sensor which interacts with a magnet arranged on a drive shaft.

It is essential that the drive controller 5 monitor the sensor signals for a fault state and initiate an emergency braking mode and/or an emergency stop mode when a fault state is detected.

There is primarily provision here that the drive controller 5 monitors the sensor signals for fault-induced slamming shut of the closure element 1. Such fault-induced slamming shut can be caused, in particular, by a drive component of the drive arrangement rupturing. It will be explained further below which drive component this may be.

Specifically when a drive component ruptures, the slamming shut movement will take place suddenly. Against this background, there is preferably provision that, in order to detect fault-induced slamming shut of the closure element 1, the drive controller 5 checks the sensor signals for sudden signal deviations. By way of clarification it can be stated in this respect that this means a deviation with respect to the signal profile occurring in the normal operating mode.

It has already been mentioned further above that fault-induced slamming shut of the closure element 1 may be due to the fact that one of the drives 2 becomes disengaged from the closure element 1. This is the case in the illustrated exemplary embodiment if, during the loading when the tailgate 1 is opened, a strong shock is inadvertently applied to one of the drives 2, which shock ruptures the drive coupling between the drive 2 and the tailgate 1 and/or the motor vehicle bodywork. This generally causes the tailgate 1 to slam shut owing to the weight of the tailgate.

For the above case it is appropriate that the drive arrangement 5 initiates an emergency braking mode and/or an emergency stop mode only for that drive 2 which follows the fault-induced slamming shut movement of the tailgate 1. This method of actuation is particularly advantageous for a case in which the emergency braking mode and/or the emergency stop mode is due to inverse energization of the drive 2, as will be explained.

In the drive arrangement with two drives 2, which each have a sensor, the detection of fault-induced slamming shut of the closure element 1 can be implemented by virtue of the fact that the sensor signals of the two sensors are correlated with one another. This means that the sensor signals of the two sensors are processed with one another in some way or other, so that the presence of the fault state can be detected from the result of the processing.

In the simplest case, the sensor signals of the two sensors are largely identical to one another in the normal operating mode. This is also the case in the illustrated exemplary embodiment with identical drives 2. In particular it is sufficient that the sensor signals of the two sensors are compared with one another, wherein the upward transgression of a predetermined signal deviation implies the occurrence of the fault state.

However, there may, for example, also be provision that, in order to detect fault-induced slamming shut of the closure element 1, the drive controller 5 monitors the upward transgression of a predetermined limiting difference in the drive speed or the drive travel experienced by the two drives 2. Other possible ways of detecting the fault state are conceivable.

There is preferably provision that the drive 2 is prestressed in the opening direction, specifically in such a way that the prestressing counteracts the weight of the tailgate 1. This will be explained in more detail below. Such prestressing generally leads, in the case of the above “tearing off” of a drive 2, to a situation in which the drive 2 carries out a sudden drive movement in the opening direction due to the prestressing. Against this background, there is preferably provision that the drive controller 5 monitors the sensor signals for the fault state of a sudden drive movement in the opening direction which is caused, in particular by prestressing of the drive 2.

In this context there is also preferably provision that the drive arrangement 5 initiates an emergency braking mode and/or emergency stop mode only for that drive 2 for which no sudden drive movement in the opening direction has just been sensed.

Various possible ways of implementing the emergency braking mode and the emergency stop mode are conceivable.

For example, it is conceivable that the drive arrangement has an actuable brake arrangement, and that, in order to initiate the emergency braking mode and/or the emergency stop mode, the drive controller 5 correspondingly actuates the brake arrangement. Given corresponding configuration of the brake arrangement, the necessary braking effect can be achieved quickly and reliably.

In a particularly preferred embodiment there is, however, provision that, in order to initiate the emergency braking mode and/or the emergency stop mode, the drive controller 5 actuates the drive motor 3 in such a way that said drive motor 3 acts in a braking fashion on adjustment of the closure element 1. The fact that additional structural measures, such as the provision of a brake arrangement, can be dispensed with is advantageous here.

The weight of the tailgate 1 can be of a considerable magnitude so that preferably a spring arrangement 6 is provided which at any rate compensates the weight of the tailgate 1 over an adjustment range of the tailgate 1. This is generally intended to ensure that the tailgate 1 is always located in the vicinity of a state of equilibrium. However, it may also be advantageous to provide over-compensation in such a way that the tailgate 1 is predisclosed to move in the opening direction. The spring arrangement 6 preferably brings about the already abovementioned prestressing of the drive 2 in the opening direction here. However, it is also conceivable that a spring arrangement is provided separately from the drive 2. This generally comprises gas compression springs or the like.

In the case of a spring fracture, the potential fault state of the undesired slamming shut of the tailgate 1 is associated with all spring arrangements which counteract the weight of the tailgate 1.

It is basically conceivable that, in order to initiate the emergency operating mode and/or the emergency stop mode, the braking of the drive motor 3 takes place in an uncontrolled fashion. However, the braking drive motor 3 preferably takes place in a controlled fashion.

The drive controller 5 preferably has a control loop 7 for controlling the motor-operated adjustment of the closure element 1, wherein the control loop 7 generates a manipulated variable 9 in the motor-operated adjustment mode on the basis of a control error, and wherein the drive motor 3 acts in a controlled driving fashion or controlled braking fashion as a function of the manipulated variable 9. “controlled driving fashion” and “controlled braking fashion” preferably mean here that the braking effect is not only switched on and off but is also “metered”, as is the driving effect of the drive motor 3. Preferred variants of such metered “braking” will be explained below.

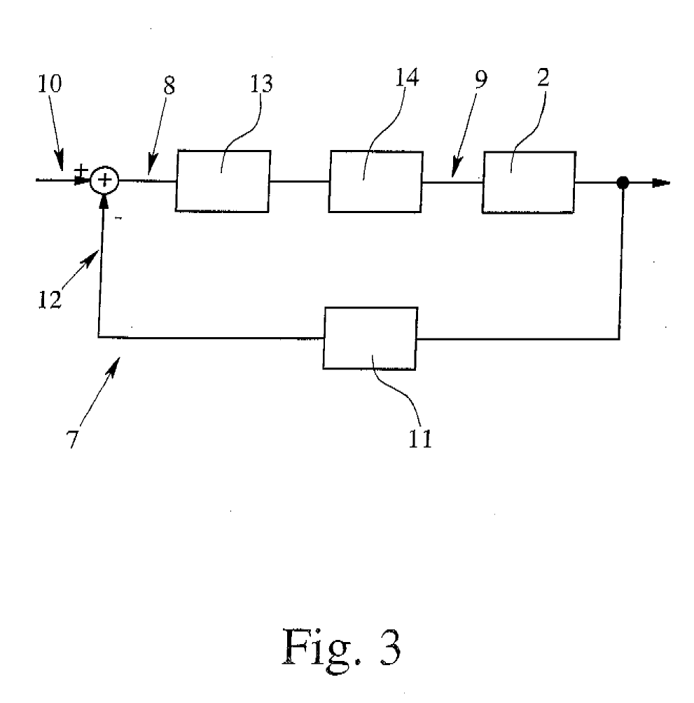

The above control loop 7 is illustrated by way of example in FIG. 3. A reference variable 10, which represents, for example, the setpoint speed of the tailgate 1, is compared with an actual variable 12 which is measured by a sensor 11, and is converted into the abovementioned control error 8. The sensor 11 is preferably the sensor of one of the two drives 2. The manipulated variable 9, which is also referred to above, for the drive 2, in particular for the drive motor 3, is generated in the controller 13 and in a downstream actuator element 14 on the basis of the control error 8.

During the equipment of the drive controller 5 with a control loop 7, the above fault state can be detected particularly easily. Such detection is then based on the detection of a sudden control error, caused, for example, by the mechanical rupture of a spring arrangement 6 which is assigned to the drive 2.

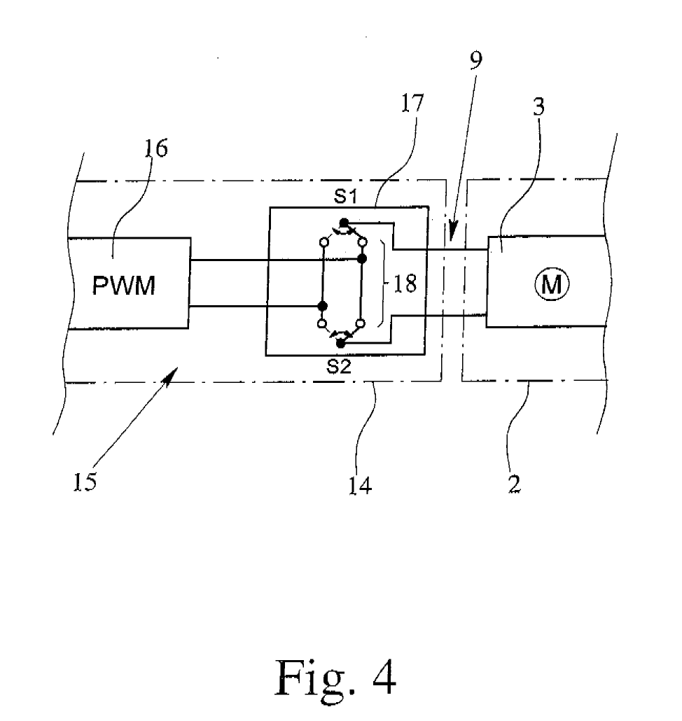

FIG. 4 shows a power output stage 15 which is assigned to the drive motor 3 and which has a PWM (Pulse Width Modulation) generator 16 as voltage source and a switching unit 17 connected downstream of the PWM generator 16. The switching unit 17 serves firstly for bidirectional connection of the drive motor 3 to the pulsed supply voltage, which is necessary for the bidirectional adjustment of the tailgate 1 in the closing direction and in the opening direction. For this purpose, the switching unit 17 has the switches S1 and S2, which are alternately switched depending on the adjustment direction. In one of the adjustment directions, the switching vane of the switch S1 is in the right-hand position and the switching vane of the switch S2 is in the left-hand position. This situation is correspondingly reversed for the opposing adjustment direction.

One particularly simple possible way of implementing the above braking effect of the drive motor 3 is also shown in FIG. 4. In order to generate the braking effect for the emergency braking mode and/or the emergency stop mode, the drive controller 5 preferably connects the drive motor 3 here to a short circuit 18. This is the case if the switching vanes of the two switches S1 and S2 which are illustrated in FIG. 4 are in the right-hand position (FIG. 4).

The variant of short-circuit braking illustrated in FIG. 4 is easy to implement, but it does not permit any “metered” braking This can be basically achieved by virtue of the fact that, in order to generate the braking effect, the drive controller 5 connects the drive motor 3 in a pulsed fashion to a short circuit 18. This is preferably done in pulsed width modulation.

In the embodiment which is illustrated in FIG. 4 and to this extent preferred, the short circuit 18 is configured in the manner of an ideal electrical short-circuit bridge. However, it is also conceivable to configure the short circuit 18 in the manner of a resistance bridge, wherein the effect of the short circuit 18 can also preferably be set by means of the drive controller 5 in that the resistance value of the resistance bridge can be set by means of the drive controller 5.

Numerous variants are conceivable for the circuitry implementation of the bidirectional actuation on the one hand and the short-circuit braking on the other. The switching unit 17 can, for example, be configured as a relay. However, it is also possible for the bidirectional actuation to the preferably implemented as a full bridge in an integrated component, and for the short-circuit braking to be implemented in a separate relay.

The explained braking effect of the drive motor by short circuiting is based, as mentioned above, on the Lorentz principle. However, this means that this cannot be used to implement braking as far the stationary state in the case of continuous loading of the tailgate 1, for example by weight.

Alternatively or additionally there is therefore preferably provision that, in order to generate a braking effect, the drive controller 5 applies a countervoltage and/or a countercurrent to the drive motor 3 which countervoltage and/or countercurrent counteracts the respective adjustment movement. This can be readily implemented with the power output stage 15 illustrated in FIG. 3 since the drive direction can, of course, be reversed through alternating connection of the switches S1 and S2. In order also to permit “metered” braking here, the drive controller 5 preferably applies a pulsed countervoltage and/or a pulsed countercurrent to the drive motor 3 in order to generate the braking effect, wherein the countervoltage and/or the countercurrent are also preferably pulsed in the manner of a pulse width signal. The metered braking can, however, also easily be implemented by setting the level of the countervoltage or of the countercurrent. In the case of the fault state of “tearing off” of one of the drives 2, the braking takes place with the countervoltage or with the countercurrent preferably only when the remaining drive 2 is in drive engagement. Otherwise, the torn-off drive 2 would carry out a drive movement in the opening direction, which is possibly associated with the risk of injury to the user. This basic concept of “one-sided” braking has already been mentioned further above.

Depending on the embodiment of the closure element 1, the emergency stop mode is associated with a continuous power drain by the drive motor 3. This is the case with the tailgate 1 which is illustrated in FIG. 1, due to the effect of weight. For this reason, there is preferably provision that the drive controller 5 remains in the stop mode only for a predetermined stopping time, and preferably motor-operated resetting of the tailgate 1 preferably into the closed position, occurs after the expiry of the stopping time. In a particularly preferred embodiment, the resetting takes place at a reduced speed. It has become apparent that stopping times between 20 and 30 minutes produce a good compromise between energy consumption on the one hand and user comfort on the other.

During the controlled stopping of the tailgate 1 above, the tailgate 1 is continuously braked and driven. The braking is carried out here by means of the abovementioned application of a countervoltage and/or a countercurrent to the drive motor 3. It goes without saying that the short-circuit braking above does not permit the tailgate 1 to be returned from deflected position into the stop position.

The utilization of the braking effect of a drive motor 3 according to the proposal can be freely applied to all possible structural variants. One particularly preferred drive 2 is illustrated in FIG. 2. In addition to the drive motor 3, the drive 2 has a spindle/spindle nut mechanism 19 which is connected downstream of the drive motor 3, wherein an intermediate mechanism 20 including a clutch is preferably connected between the drive motor 3 and the spindle/spindle nut mechanism 19 here. The spring arrangement 6 is integrated into the drive 2, with the result that overall a particularly compact embodiment is obtained. With respect to the structural configuration of the drive 2, in particular with respect to the structural configuration of the spring arrangement 6, reference can be made to German application DE 20 2005 007 155 U1, which is by the applicant and which is herewith made, in its entire scope, a subject matter of the present application.

It has already been pointed out that the teaching according to the proposal can be applied to all types of closure elements 1 in a motor vehicle. However, the closure element 1 is preferably configured as a flap, in particular as a tailgate 1 or as a trunk lid.

According to a further teaching, which is also attributed independent significance, a closure element arrangement, in particular a tailgate arrangement, in a motor vehicle is claimed which has a closure element and a drive arrangement, as explained above. Reference can be made to the full scope of the above statements.

1. A drive arrangement for motor-operated adjustment of a closure element in a motor vehicle, wherein at least one drive with a drive motor, and a drive controller are provided, wherein the closure element can be driven in the motor-operated adjustment mode by means of the drive motor in the closing direction and in the opening direction between a closed position and an open position, wherein the drive is of non-self-locking design, wherein the drive has a sensor, in particular a Hall sensor, for sensing the drive movement,
wherein the drive controller monitors the sensor signals for a fault state, and when a fault state is sensed said drive controller initiates a mode selected from an emergency braking mode, ambler an emergency stop mode, and a combination thereof, and the drive arrangement comprises two drives each with a sensor for determining the respective drive movement, and in-that, in order to detect fault-induced slamming shut of the closure element, the drive controller correlates the sensor signals of the two sensors with one another.

2. The drive arrangement as claimed in claim 1, wherein the drive controller monitors the sensor signals for fault-induced slamming shut of the closure element.

3. The drive arrangement as claimed in claim 1, wherein the drive arrangement comprises two drives each with a sensor for determining the respective drive movement, and in that the drive arrangement initiates a mode selected from an emergency braking mode, an emergency stop mode, and combinations thereof only for that drive which follows a fault-induced slamming shut movement of the closure element.

4. The drive arrangement as claimed in claim 1, wherein, in order to detect fault-induced slamming shut of the closure element, the drive controller monitors the upward transgression of a predetermined limiting difference in the drive speed or the drive travel of the two drives.

5. The drive arrangement as claimed in claim 1, wherein the drive controller monitors the sensor signals for the fault state of a sudden drive movement in the opening direction.

6. The drive arrangement as claimed in claim 5, wherein the drive arrangement comprises two drives each with a sensor for determining the respective drive movement, and the drive arrangement initiates a mode selected from an emergency braking mode, an emergency stop mode, and combinations thereof only for that drive for which no sudden drive movement in the opening direction has been sensed.

7. The drive arrangement as claimed in claim 1, wherein, in order to initiate the mode selected from the emergency braking mode, the emergency stop mode, and combinations thereof, the drive arrangement has an actuable brake arrangement, and the drive controller correspondingly actuates the brake arrangement.

8. The drive arrangement as claimed in claim 1, wherein, in order to initiate the mode selected from the emergency braking mode, the emergency stop mode, and combinations thereof, the drive controller actuates the drive motor in such a way that said drive motor acts in a braking fashion on adjustment of the closure element.

9. The drive arrangement as claimed in claim 1, wherein the drive controller comprises a control loop for controlling the motor-operated adjustment of the closure element, the control loop generates a manipulated variable in the motor-operated adjustment mode on the basis of a control error, and the drive motor acts in a controlled driving fashion or controlled braking fashion as a function of the manipulated variable.

10. The drive arrangement as claimed in claim 1, wherein, in order to generate a braking effect for the mode selected from the emergency braking mode, the emergency stop mode, and combinations thereof, the drive controller (5) connects the drive motor (3) to a short circuit.

11. The drive arrangement as claimed in claim 10, wherein the short circuit is configured in a the manner of an ideal electrical short-circuit bridge, or in a manner of a resistance bridge.

12. The drive arrangement as claimed in claim 1, wherein, in order to generate a braking effect, the drive controller applies an action selected from the group of a countervoltage, a countercurrent, and combinations thereof to the drive motor, which action counteracts the respective adjustment movement.

13. The drive arrangement as claimed in claim 1, wherein the drive has a spindle/spindle nut mechanism which is connected downstream of the drive motor (3).

14. The drive arrangement as claimed in claim 1, wherein the drive motor is configured as a direct current motor.

15. The drive arrangement as claimed in claim 1, wherein the closure element is configured as a flap of a motor vehicle selected from the group of a tailgate and a trunk lid.

16. (canceled)

17. The drive arrangement of claim 1, wherein the drive controller compares said sensor signals with one another.

18. The drive arrangement of claim 2, wherein the drive controller monitors the sensor signal for slamming shut due to the breakage of a drive component.

19. The drive arrangement of claim 2, wherein the drive controller monitors the sensor signals for sudden signal deviations.

20. The drive arrangement of claim 5, wherein the sudden drive movement is caused by prestressing of the drive.

20. The drive arrangement of claim 10, wherein, in order to generate a braking effect, the drive controller connects the drive motor in a pulsed fashion to a short circuit.

21. The drive arrangement of claim 20, wherein the pulsed connection takes place in pulse width modulation.

22. The drive arrangement of claim 11, wherein the effect of the short circuit can be set by means of the drive controller in that the resistance value of the resistance bridge can be set by means of the drive controller.

23. The drive arrangement of claim 12, wherein the drive controller applies an action selected from a pulsed countervoltage, a pulsed countercurrent, and combinations thereof to the drive motor.

24. The drive arrangement of claim 23, wherein the action is pulsed in the manner of a pulse width signal.

25. The drive arrangement of claim 13, wherein an intermediate mechanism is connected between the drive motor and the spindle/spindle nut mechanism.
